(19) United States
(12) Patent Application Publication
(10) Pub. No.: US 2026/0181493 A1
(43) Pub. Date: Jun. 25, 2026

(54) Conditional Transmission Configuration Indicator Switch

(71) Applicant: Apple Inc., CUPERTINO, CA (US)

(72) Inventors: Dawei ZHANG, Saratoga, CA (US); Jie CUI, San Jose, CA (US); Manasa RAGHAVAN, Sunnyvale, CA (US); Qiming LI, Beijing (CN); Xiang CHEN, Campbell, CA (US); Yang TANG, San Jose, CA (US)

(21) Appl. No.: 18/835,484

(22) PCT Filed: Aug. 2, 2023
(86) PCT No.: PCT/CN2023/110690

§ 371 Date: Aug. 2, 2024

(51) Int. Cl. H04W 36/00; H04W 36/32

(52) U.S. Cl. CPC H04W 36/0072; H04W 36/0085; H04W 36/328

(57) ABSTRACT

A user equipment (UE) configured to decode, from signaling received from a base station, one or more transmission configuration indicator (TCI) switch conditions for each of one or more candidate TCI of a serving cell, determine that one of the one or more candidate TCI satisfies the corresponding one or more TCI switch conditions and perform a TCI switch from a current active TCI to the one of the one or more candidate TCI.

### TECHNICAL FIELD

This application relates generally to wireless communication systems, and in particular relates to conditional transmission configuration indicator switch.

### BACKGROUND

Beam management for a user equipment (UE) includes an indication of a transmission configuration indicator (TCI) that provides information to the UE regarding the beam(s) the UE should use for communicating in both the downlink (DL) and the uplink (UL). As the UE moves from coverage of a first beam to coverage of a second beam, the network needs to update the TCI for both the DL and the UL using a TCI switch. This TCI switch is triggered by the network. However, in some time sensitive scenarios (e.g., ultra-reliable low latency communications (URLLC), UE on a high speed train, etc.) the TCI may not be updated in a timely manner when the UE is moving.

### SUMMARY

Some example embodiments are related to an apparatus of a user equipment (UE), the apparatus having processing circuitry configured to decode, from signaling received from a base station, one or more transmission configuration indicator (TCI) switch conditions for each of one or more candidate TCI of a serving cell, determine that one of the one or more candidate TCI satisfies the corresponding one or more TCI switch conditions and perform a TCI switch from a current active TCI to the one of the one or more candidate TCI.

Other example embodiments are related to a processor configured to decode, from signaling received from a base station, one or more transmission configuration indicator (TCI) switch conditions for each of one or more candidate TCI of a serving cell, determine that one of the one or more candidate TCI satisfies the corresponding one or more TCI switch conditions and perform a TCI switch from a current active TCI to the one of the one or more candidate TCI.

Still further example embodiments are related to an apparatus of a base station, the apparatus having processing circuitry configured to decode, from signaling received from a user equipment (UE), a UE capability indicating the UE supports conditional transmission configuration indicator (TCI) switching, configure one or more TCI switch conditions for each of one or more candidate TCI of the base station and configure transceiver circuitry to transmit the one or more TCI switch conditions for each of one or more candidate TCI to the UE.

Additional example embodiments are related to a processor configured to decode, from signaling received from a user equipment (UE), a UE capability indicating the UE supports conditional transmission configuration indicator (TCI) switching, configure one or more TCI switch conditions for each of one or more candidate TCI of the base station and configure transceiver circuitry to transmit the one or more TCI switch conditions for each of one or more candidate TCI to the UE.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example of a network arrangement where a UE is moving within a coverage area of a serving cell according to various example embodiments.

FIG. 5 shows an example method for a UE to perform a TCI switch according to various example embodiments.

FIG. 6 shows an example signaling diagram for a UE to report a UE capability related to supporting a conditional TCI switch according to various example embodiments.

### DETAILED DESCRIPTION

The example embodiments may be further understood with reference to the following description and the related appended drawings, wherein like elements are provided with the same reference numerals. The example embodiments relate to a conditional Transmission Configuration Indicator (TCI) switch.

Some example embodiments described relate to a user equipment (UE). The example UE described herein may be equipped with multiple panels each comprising one or more antenna elements. However, reference to a UE is merely provided for illustrative purposes. The example embodiments may be utilized with any electronic component that may establish a connection to a network and is configured with the hardware, software, and/or firmware to support gapless RRM measurements. Therefore, the UE as described herein is used to represent any appropriate type of electronic component.

Some example embodiments described relate to a fifth generation (5G) New Radio (NR) network. However, reference to a 5G NR network is merely provided for illustrative purposes. The example embodiments may be utilized with any appropriate type of network, e.g., 5G, 5G-advanced, 6G, etc.

As described above, current methods of performing TCI switches may not be timely for high speed or low latency scenarios. The example embodiments provide manners of a UE initiating a TCI switch. By allowing the UE to initiate the TCI switch, the TCI switch may be performed faster than when the network triggers the TCI switch. This may resolve the issue of the timeliness of the TCI switch in the high speed or low latency scenarios. The example embodiments are described in greater detail below.

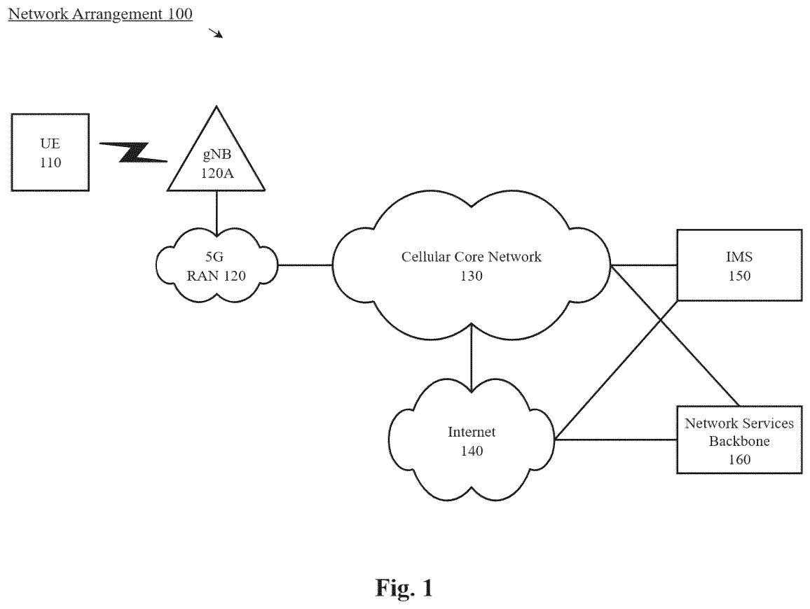

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generate RAN (NG-RAN), a legacy cellular network, a wireless local area network (WLAN), etc.) and the UE 110 may also communicate with networks over a wired connection. Therefore, the UE 110 may have a 5G NR chipset to communicate with the NR RAN 120 and, optionally, any other appropriate type of chipset to communicate with other types of networks.

The 5G NR RAN 120 may be a portion of a cellular network that may be deployed by a network carrier (e.g., Verizon, AT&T, Sprint, T-Mobile, etc.). The 5G NR RAN 120 may include cells and base stations that are configured to send and receive traffic from UEs that are equipped with the appropriate cellular chip set. In this example, the 5G NR RAN 120 includes the next generation Node B (gNB) 120A. However, reference to a gNB is merely provided for illustrative purposes, the example embodiments may be utilized with any appropriate type of access node (e.g., Node Bs, evolved NodeBs (eNBs), Home eNBs (HeNBs), gNBs, macrocells, microcells, small cells, femtocells, etc.).

Any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A).

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

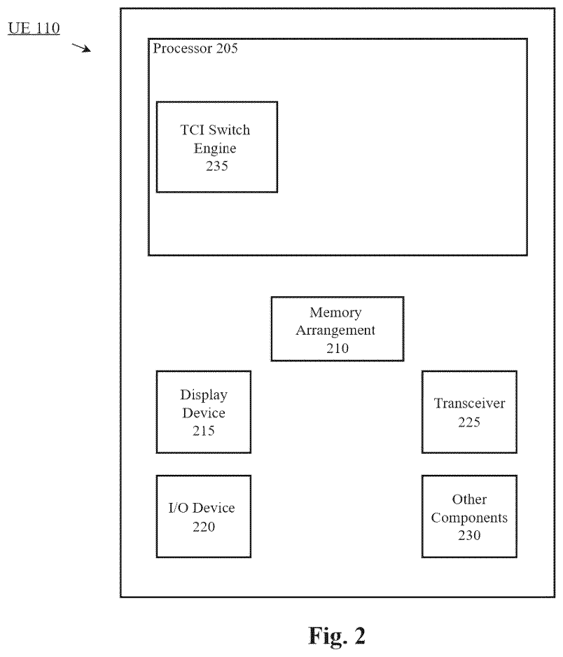

FIG. 2 shows an example UE 110 according to various example embodiments. The UE 110 will be described in relation to the network arrangement 100 of FIG. 1. The UE 110 may include a processor 205, a memory arrangement 210, a display device 215, an input/output (I/O) device 220, a transceiver 225 and other components 230. The other components 230 may be, for example, multiple panels each comprising one or more antenna elements, an audio input device, an audio output device, a power supply, a data acquisition device, ports to electrically connect the UE 110 to other electronic devices, etc.

The processor 205 may be configured to execute a plurality of engines of the UE 110. For example, the engines may include a TCI switch engine 235. The TCI switch engine 235 may perform various operations related to the UE performing a TCI switch including, but not limited to, reporting a UE capability related to supporting TCI switching, monitoring for TCI switching conditions to be satisfied and reporting a TCI switch to the network. These example operations are described in further detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

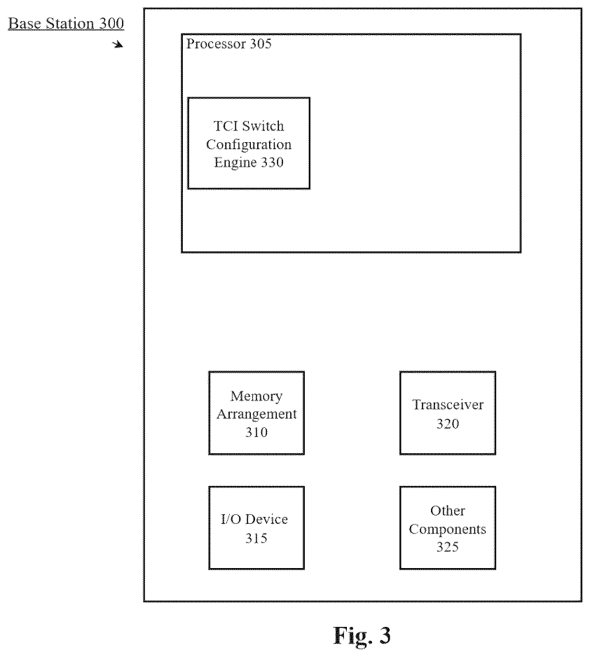

FIG. 3 shows an example base station 300 according to various example embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines of the base station 300. For example, the engines may include a TCI switch configuration engine 330. The TCI switch configuration engine 330 may perform various operations related to the configuring a UE to perform TCI switching. These operations may include, but are not limited to, receiving a UE capability related to TCI switching and configuring the UE with conditions related to TCI switching. These example operations are described in further detail below.

The above noted engine 330 being an application (e.g., a program) executed by the processor 305 is only example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

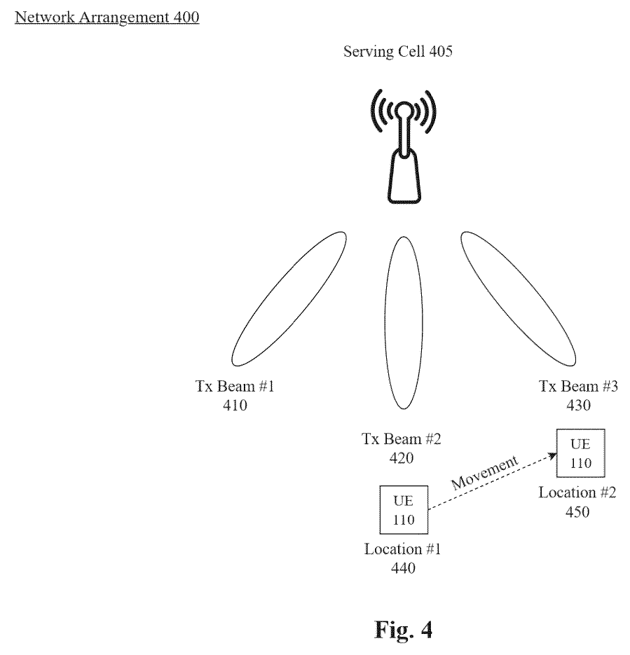

FIG. 4 shows an example of a network arrangement 400 where a UE 110 is moving within a coverage area of a serving cell 405 according to various example embodiments. The network arrangement 400 includes the UE 110 described above with reference to FIGS. 1 and 2 and a serving cell 405 that may be, for example, the gNB 120A described above with reference to FIGS. 1 and 3.

In the example of FIG. 4, the serving cell 405 is shown as having three (3) transmission (Tx) beams, Tx beam #1 410, Tx beam #2 420, and Tx beam #3 430. In this example, the transmission beams (e.g., the beams used for the DL) of the serving cell 405 are illustrated, but as will be described in greater detail below, the TCI switch may also apply to beams used for UL, e.g., to the reception (Rx) beams by the serving cell 405.

Initially, the UE 110 is located at location 1 440 within the coverage area of the serving cell 405. At the location 1 440, the UE 110 uses the Tx beam #2 420 to receive DL signals from the serving cell 405. The UE 110 may then move to location 2 450 within the coverage area of the serving cell 405. When at location 2 450, the UE 110 uses the Tx beam #3 430 to receive DL signals from the serving cell 405. To accomplish this switch from the Tx beam #2 420 to the Tx beam #3 430, the network (e.g., serving cell 405) will trigger a TCI switch. Conventionally, the TCI switch is triggered based on layer 1 (L1) measurements performed by the UE 110. The serving cell 405 configures the UE 110 to perform the L1 measurements on a set of candidate beams and report the L1 measurements to the serving cell 405. Based on these L1 measurements, the serving cell 405 will trigger the TCI switch at an appropriate time. However, as described above, in some time sensitive scenarios (e.g., ultra-reliable low latency communications (URLLC), UE on a high speed train, etc.) the TCI switch may not be triggered by the serving cell in a timely manner.

The example embodiments provide manners for a UE to be configured with conditions for the UE to initiate the TCI switch based on the conditions. As will be described in greater detail below, the UE initiating the TCI switch results in a faster TCI switch because, for example, the time for the UE to report the L1 measurements to the serving cell and for the serving cell to send the TCI switch command to the UE is eliminated, resulting in a faster TCI switch.

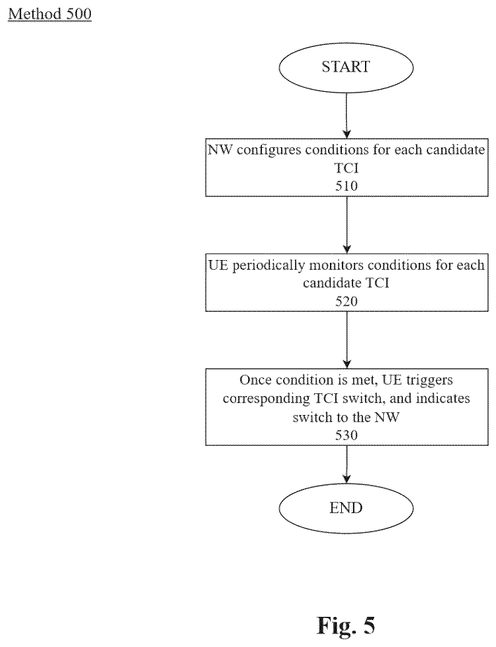

FIG. 5 shows an example method 500 for a UE to perform a TCI switch according to various example embodiments. The method 500 is described with reference to the scenario shown in FIG. 4, e.g., the UE 110 being in communication with the serving cell 405 and moving from the coverage area of the Tx beam #2 420 to the coverage area of the Tx beam #3 430. The operations described in the example method 500 are described from the standpoint of both the network (e.g., the serving cell 405) and the UE 110.

Initially, as described above, the UE 110 may be located at location 1 440 within the coverage area of the serving cell 405 and receiving DL signals using the Tx beam #2 420. In 510, the network configures conditions for each candidate TCI, e.g., conditions for the UE to initiate a TCI switch. The conditions may be configured by the serving cell 405 or any other component of the radio access network (RAN) (e.g., RAN 120) or the core network 130. The serving cell 405 may signal the conditions using control signaling. For example, the serving cell 405 may signal the conditions using Radio Resource Control (RRC) signaling. While this configuration is being described as occurring when the UE 110 is located at location 1 440 within the coverage area of the serving cell 405 and receiving DL signals using the Tx beam #2 420, the signaling can occur at some other time. For example, the serving cell 405 may signal to the UE 110 conditions for each candidate TCI each time the TCI state changes, each time the UE switches a serving cell, each time the UE performs a registration area update (RAU), etc. That is, the UE 110 may be configured with the TCI switch conditions at any time.

When the network triggers a TCI switch, it is typically based on L1 measurements on candidate beams performed by the UE 110 and reported to the serving cell 405. The conditions for the TCI switch that are configured for the UE 110 may be, for example, using the same L1 measurements on candidate beams or any other conditions that may be used to indicate that a TCI switch is appropriate. Some other example conditions may include, for example, altitude in an air-to-ground (ATG) scenario, UE location, etc.

To provide some examples related to the L1 measurements, the conditions may include L1 measurement thresholds for measured parameters such as a L1-Reference Signal Received Power (L1-RSRP) in dBm, L1-Signal to Noise Ratio (L1-SINR) in dB, etc. for each candidate beam. The values (e.g., thresholds) may be based on an absolute value or a relative value compared to L1 measurements associated with a current TCI. The conditions for the TCI switch may be singular (e.g., if a single condition is satisfied, the TCI switch may occur) or may be a combination of two or more conditions (e.g., all the conditions of the combination need to be satisfied to initiate the TCI switch).

In 520, the UE 110 monitors conditions of all the candidate TCI. For example, if the conditions are based on the L1 measurements, the UE 110 periodically performs the L1 measurements and determines whether the measurement results meet the conditions of the corresponding TCI. In one example, the L1 measurement periodicity may be the same as is currently defined by the 3GPP standards (e.g., as indicated in Technical Specification (TS) 38.133) for the network-initiated TCI switch. In another example, the L1 measurement periodicity may be redefined in the 3GPP standards for the UE initiated TCI switch.

Similarly, if other conditions are configured (e.g., altitude, UE location, etc.) the UE 110 may also periodically monitor the related parameters and determine if the values of one or more parameters satisfy the condition(s) for the TCI switch. In some examples, the periodicity of monitoring for the conditions may be based on UE implementation. In other examples, the network (e.g., the serving cell 405) may signal (e.g., via RRC signaling) the periodicity of monitoring for the conditions. The network may configure different values in different deployments.

In 530, one or more of the conditions may have been satisfied. Thus, in 530, the UE 110 triggers the corresponding TCI switch and indicates the TCI switch to the network by signaling the serving cell 405. For example, referring to FIG. 4, the UE 110 may move the location 1 440 to the location 2 450. At some point during this move, one or more TCI switch conditions for switching to the Tx beam #3 430 should be satisfied. When the TCI switch conditions(s) are satisfied, the UE 110 will switch the TCI from the moving from the Tx beam #2 420 to the Tx beam #3 430. The UE 110 will then report this TCI switch to the serving cell 405 so that the network understands that the UE 110 has initiated the TCI switch to the Tx beam #3 430, e.g., the network can use the new TCI for data scheduling. The report of the TCI switch from the UE 110 to the serving cell 405 may include a new UL indication that includes, for example, the new TCI ID (e.g., the TCI ID of the Tx beam #3 430).

While the example embodiments described herein reference Tx beams (e.g., DL), the TCI switch may also be performed in a substantially similar manner for the Rx beams (e.g., UL). In some examples, when the conditions for the TCI switch are satisfied for either the Tx beams or Rx beams, the UE 110 may switch both depending on the network configuration.

In the above example, it was considered that the network configured the UE 110 with the conditions to initiate the TCI switch. However, prior to the network configuring the UE 110 with the conditions to initiate the TCI switch, the UE 110 may signal the network to communicate that the UE 110 supports the conditional TCI switch.

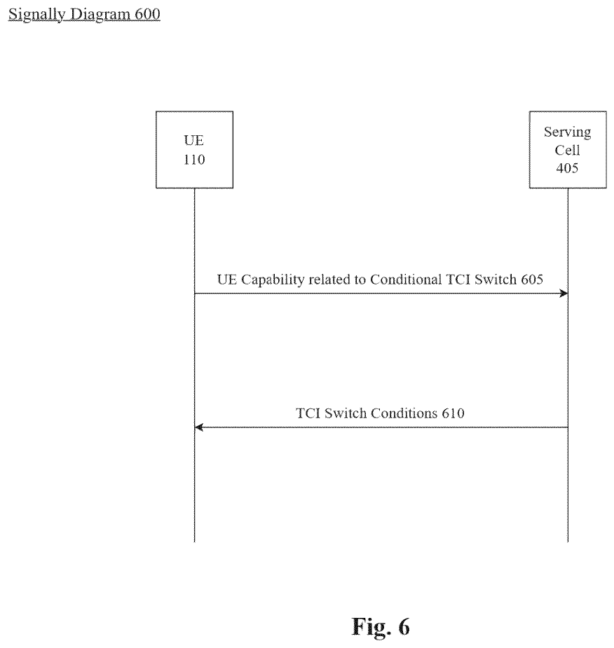

FIG. 6 shows an example signaling diagram 600 for a UE to report a UE capability related to supporting a conditional TCI switch according to various example embodiments. In 605, the UE 110 reports UE capabilities to the serving cell 405. The UE 110 may report multiple different types of UE capabilities to the network so that the network understands the various capabilities of the UE 110. This reporting is typically performed using RRC signaling but it is not required to be RRC signaling.

In the example of FIG. 6, a new UE capability is introduced for the UE 110 to indicate support of a conditional TCI switch. For example, a new information element (IE) may be used to indicate that the UE 110 supports the conditional TCI switch. This IE may be a Boolean value (e.g., true/false) as to whether the UE 110 supports conditional TCI switch or may also include information as to the type of conditional TCI switching the UE supports. For example, the IE may indicate support for conditions based on L1 measurements (e.g., L1-RSRP, L1-SINR, etc.), support for conditions based on altitude, support for conditions based on UE location, etc. This new capability may be indicated per UE or per frequency range (FR).

Once the network understands that the UE 110 supports the conditional TCI switch, in 610, the network may configure the UE 110 with the TCI switch conditions. The operations for configuring the UE 110 with the TCI switch conditions were described in detail above with reference to 510 of FIG. 5.

### Examples

In a first example, a method is performed by a user equipment (UE), comprising decoding, from signaling received from a base station, one or more transmission configuration indicator (TCI) switch conditions for each of one or more candidate TCI of a serving cell, determining that one of the one or more candidate TCI satisfies the corresponding one or more TCI switch conditions and performing a TCI switch from a current active TCI to the one of the one or more candidate TCI.

In a second example, the method of the first example, wherein the one or more TCI switch conditions is decoded from Radio Resource Control (RRC) signaling received from the base station.

In a third example, the method of the first example, wherein the one or more TCI switch conditions comprise a threshold for a parameter.

In a fourth example, the method of the third example, wherein the parameter comprises a layer 1 (L1) measurement parameter for each of the one or more candidate TCI.

In a fifth example, the method of the fourth example, wherein the L1 measurement parameter comprises a L1-Reference Signal Received Power (L1-RSRP) parameter or a L1-Signal to Noise Ratio (L1-SINR) parameter.

In a sixth example, the method of the fourth example, wherein the threshold for the L1 measurement parameter is an absolute value or a relative value compared to an L1 measurement associated with the current active TCI.

In a seventh example, the method of the fourth example, further comprising periodically monitoring the L1 measurement parameter to determine whether the one of the one or more candidate TCI satisfies the one or more TCI switch conditions, wherein a period for monitoring the L1 measurement parameter is predetermined.

In an eighth example, the method of the third example, wherein the parameter comprises an altitude of the UE or a location of the UE.

In a ninth example, the method of the eighth example, further comprising periodically monitoring the altitude or a location of the UE to determine whether the one of the one or more candidate TCI satisfies the one or more TCI switch conditions.

In a tenth example, the method of the ninth example, wherein a period for monitoring the altitude or a location of the UE is stored in the UE or decoded from signaling received from the base station.

In an eleventh example, the method of the first example, wherein the one or more candidate TCI are downlink TCI or uplink TCI of the serving cell.

In a twelfth example, the method of the eleventh example, wherein, when the one or more candidate TCI are downlink TCI, the TCI switch to the one of the one or more candidate TCI further comprises a further TCI switch to a corresponding uplink TCI.

In a thirteenth example, the method of the first example, further comprising configuring transceiver circuitry to transmit an indication of the TCI switch to the serving cell, wherein the indication comprises a TCI identification of the one of the one or more candidate TCI.

In a fourteenth example, the method of the first example, further comprising configuring transceiver circuitry to transmit a UE capability indicating the UE supports conditional TCI switching.

In a fifteenth example, the method of the fourteenth example, wherein the UE capability further indicates a type of conditions supported by the UE for conditional TCI switching, wherein the type of conditions comprise L1 measurement conditions, altitude conditions or locations conditions.

In a sixteenth example, the method of the fourteenth example, wherein the UE capability is indicated per UE or per frequency range (FR).

In a seventeenth example, a processor configured to perform any of the methods of the first through sixteenth examples.

In an eighteenth example, a user equipment (UE) comprising a transceiver configured to communicate with a network and a processor communicatively coupled to the transceiver and configured to perform any of the methods of the first through sixteenth examples.

In a nineteenth example, a method performed by a base station, comprising decoding, from signaling received from a user equipment (UE), a UE capability indicating the UE supports conditional transmission configuration indicator (TCI) switching, configuring one or more TCI switch conditions for each of one or more candidate TCI of the base station and configuring transceiver circuitry to transmit the one or more TCI switch conditions for each of one or more candidate TCI to the UE.

In a twentieth example, the method of the nineteenth example, further comprising decoding, from signaling received from the UE, an indication of a TCI switch to one of the one or more candidate TCI, wherein the indication comprises a TCI identification of the one of the one or more candidate TCI.

In a twenty first example, the method of the nineteenth example, wherein the one or more TCI switch conditions is transmitted via Radio Resource Control (RRC) signaling.

In a twenty second example, the method of the nineteenth example, wherein the one or more TCI switch conditions comprise a threshold for a parameter.

In a twenty third example, the method of the twenty second example, wherein the parameter comprises a layer 1 (L1) measurement parameter for each of the one or more candidate TCI.

In a twenty fourth example, the method of the twenty third example, wherein the L1 measurement parameter comprises a L1-Reference Signal Received Power (L1-RSRP) parameter or a L1-Signal to Noise Ratio (L1-SINR) parameter.

In a twenty fifth example, the method of the twenty third example, wherein the threshold for the L1 measurement parameter is an absolute value or a relative value compared to an L1 measurement associated with the current active TCI.

In a twenty sixth example, the method of the twenty second example, wherein the parameter comprises an altitude of the UE or a location of the UE.

In a twenty seventh example, the method of the twenty sixth example, further comprising configuring transceiver circuitry to transmit a periodicity for monitoring the altitude or location of the UE.

In a twenty eighth example, the method of the nineteenth example, wherein the one or more candidate TCI are downlink TCI or uplink TCI of the serving cell.

In a twenty ninth example, the method of the nineteenth example, wherein the UE capability further indicates a type of conditions supported by the UE for conditional TCI switching, wherein the type of conditions comprise L1 measurement conditions, altitude conditions or locations conditions.

In a thirtieth example, the method of the twenty ninth example, wherein the UE capability is indicated per UE or per frequency range (FR).

In a thirty first example, a processor configured to perform any of the methods of the nineteenth through thirtieth examples.

In an thirty second example, a base station comprising a transceiver configured to communicate with a user equipment (UE) and a processor communicatively coupled to the transceiver and configured to perform any of the methods of the nineteenth through thirtieth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, from signaling received from a base station, one or more transmission configuration indicator (TCI) switch conditions for each of one or more candidate TCI of a serving cell;
determine that one of the one or more candidate TCI satisfies the corresponding one or more TCI switch conditions; and
perform a TCI switch from a current active TCI to the one of the one or more candidate TCI.

2. The apparatus of claim 1, wherein the one or more TCI switch conditions is decoded from Radio Resource Control (RRC) signaling received from the base station.

3. The apparatus of claim 1, wherein the one or more TCI switch conditions comprise a threshold for a parameter.

4. The apparatus of claim 3, wherein the parameter comprises a layer 1 (L1) measurement parameter for each of the one or more candidate TCI.

5. The apparatus of claim 4, wherein the L1 measurement parameter comprises a L1-Reference Signal Received Power (L1-RSRP) parameter or a L1-Signal to Noise Ratio (L1-SINR) parameter.

6. The apparatus of claim 4, wherein the threshold for the L1 measurement parameter is an absolute value or a relative value compared to an L1 measurement associated with the current active TCI.

7. The apparatus of claim 4, wherein the processing circuitry is further configured to:
periodically monitor the L1 measurement parameter to determine whether the one of the one or more candidate TCI satisfies the one or more TCI switch conditions, wherein a period for monitoring the L1 measurement parameter is predetermined.

8. The apparatus of claim 3, wherein the parameter comprises an altitude of the UE or a location of the UE.

9. The apparatus of claim 8, wherein the processing circuitry is further configured to:
periodically monitor the altitude or a location of the UE to determine whether the one of the one or more candidate TCI satisfies the one or more TCI switch conditions.

10. The apparatus of claim 9, wherein a period for monitoring the altitude or a location of the UE is stored in the UE or decoded from signaling received from the base station.

11. The apparatus of claim 1, wherein the one or more candidate TCI are downlink TCI or uplink TCI of the serving cell.

12. The apparatus of claim 11, wherein, when the one or more candidate TCI are downlink TCI, the TCI switch to the one of the one or more candidate TCI further comprises a further TCI switch to a corresponding uplink TCI.

13. The apparatus of claim 1, wherein the processing circuitry is configured to:
configure transceiver circuitry to transmit an indication of the TCI switch to the serving cell, wherein the indication comprises a TCI identification of the one of the one or more candidate TCI.

14. The apparatus of claim 1, wherein the processing circuitry is configured to:
configure transceiver circuitry to transmit a UE capability indicating the UE supports conditional TCI switching.

15. The apparatus of claim 14, wherein the UE capability further indicates a type of conditions supported by the UE for conditional TCI switching, wherein the type of conditions comprise L1 measurement conditions, altitude conditions or locations conditions.

16. The apparatus of claim 14, wherein the UE capability is indicated per UE or per frequency range (FR).

17. An apparatus of a base station, the apparatus comprising processing circuitry configured to:
decode, from signaling received from a user equipment (UE), a UE capability indicating the UE supports conditional transmission configuration indicator (TCI) switching;
configure one or more TCI switch conditions for each of one or more candidate TCI of the base station; and
configure transceiver circuitry to transmit the one or more TCI switch conditions for each of one or more candidate TCI to the UE.

18. The apparatus of claim 17, wherein the processing circuitry is configured to:
decode, from signaling received from the UE, an indication of a TCI switch to one of the one or more candidate TCI, wherein the indication comprises a TCI identification of the one of the one or more candidate TCI.

19. The apparatus of claim 17, wherein the one or more TCI switch conditions is transmitted via Radio Resource Control (RRC) signaling.

20. The apparatus of claim 17, wherein the one or more TCI switch conditions comprise a threshold for a parameter.
